(19) United States
(12) Patent Application Publication
(10) Pub. No.: US 2024/0072281 A1
(43) Pub. Date: Feb. 29, 2024

(54) LEAK INSPECTION METHOD

(71) Applicant: HONDA MOTOR CO., LTD., Tokyo (JP)

(72) Inventors: Hitoshi NAGASAKI, WAKO-SHI, SAITAMA-KEN (JP); Takehiro MUGISHIMA, WAKO-SHI, SAITAMA-KEN (JP); Kotaro HORIAI, WAKO-SHI, SAITAMA-KEN (JP)

(21) Appl. No.: 18/238,664

(22) Filed: Aug. 28, 2023

(30) Foreign Application Priority Data
Aug. 31, 2022 (JP) 2022-137846

(51) Int. Cl. H01M 8/0438; G01M 3/26; H01M 8/04537; H01M 8/04746

(52) U.S. Cl. CPC H01M 8/04395; G01M 3/26; H01M 8/04388; H01M 8/04552; H01M 8/04753

(57) ABSTRACT

A leak inspection method includes: a gas confining step of confining a fuel gas with a predetermined pressure in a fuel gas flow field; a gas supply step of continuing to supply an oxygen-containing gas with a pressure equal to or higher than a predetermined pressure or equal to or lower than the predetermined pressure to an oxygen-containing gas flow field; and a measurement step of measuring the amount of pressure change per unit time of the gas confined in the gas confining step, when a switch provided to a wiring connecting an anode and a cathode without passing through an electrolyte membrane is in an OFF state.

### CROSS-REFERENCE TO RELATED APPLICATIONS

This application is based upon and claims the benefit of priority from Japanese Patent Application No. 2022-137846 filed on Aug. 31, 2022, the contents of which are incorporated herein by reference.

### BACKGROUND OF THE INVENTION

### Field of the Invention

The present invention relates to a leak inspection method for fuel cells.

### Description of the Related Art

In recent years, there has been research and development on fuel cells that contribute to energy efficiency to ensure that more people have access to affordable, reliable, sustainable and modern energy. In addition, in order to reduce the load given to the environment, the regulation of exhaust gas from mobile bodies such as automobiles with internal combustion engines is further advancing. Therefore, it has been attempted to mount a fuel cell instead of an internal combustion engine in a mobile body. Since the mobile body with a fuel cell does not emit CO₂, SO_{X}, NO_{X}, etc., the load on the environment is reduced.

The fuel cell includes an electrolyte membrane. In the case of a fuel cell, the generation performance of the fuel cell reduces when the electrolyte membrane is broken and pin holes or the like are formed. Therefore, a leakage inspection method is performed to inspect for a leak (cross-leak, crossover leakage) through the electrolyte membrane.

For example, in the case of the inspection method disclosed in JP 2012-133997 A, high-pressure gas is confined in a fuel gas flow field to which fuel gas is supplied, and an oxygen-containing gas flow field to which oxygen-containing gas is supplied is opened to the atmosphere. In this state, the gas pressure of the high-pressure gas is measured, and based on the measurement result, leak (cross-leak) through the electrolyte membrane is judged.

### SUMMARY OF THE INVENTION

However, since there is no atmosphere in space, the pressure difference between the fuel gas flow field and the oxygen-containing gas flow field becomes excessive if the inspection method of JP 2012-133997 A is used. Therefore, there is a concern that the electrolyte membrane may be damaged due to the pressure difference between the fuel gas flow field and the oxygen-containing gas flow field. In addition to this, there is a request to perform a leak inspection using gases other than those used for power generation of fuel cells because of the restrictions of their delivery to space. Therefore, performing the inspection of a leak through an electrolyte membrane using limited resources was raised as a challenge.

An object of the present invention is to solve the aforementioned problems.

The aspect of the present invention is a method for inspecting a leak from an electrolyte membrane in a fuel cell including the electrolyte membrane and an anode and a cathodes that sandwich the electrolyte membrane, the method including: a gas confining step of confining a fuel gas at a predetermined pressure in a fuel gas flow field for supplying the fuel gas to the anode or confining an oxygen-containing gas at the predetermined pressure in an oxygen-containing gas flow field for supplying the oxygen-containing gas to the cathode; a gas supply step of continuing to supply the oxygen-containing gas at a pressure equal to or higher than the predetermined pressure or equal to or lower than the predetermined pressure to the oxygen-containing gas flow field when the fuel gas is confined in the fuel gas flow field, and continuing to supply the fuel gas at a pressure equal to or higher than the predetermined pressure or equal to or lower than the predetermined pressure to the fuel gas flow field when the oxygen-containing gas is confined in the oxygen-containing gas flow field; and a measurement step of measuring the amount of pressure change per unit time of the gas confined in the gas confining step, when a switch provided to a wiring connecting the anode and the cathode without passing through the electrolyte membrane is in an OFF state.

According to the aspect of the present invention, it is possible to suppress the breakage of the electrolyte membrane due to the pressure difference between the fuel gas flow field and the oxygen-containing gas flow field by using only the gas essential for the power generation of the fuel cell. In addition, power generation of the fuel cell is suppressed when the anode and the cathode are not connected. Therefore, in the aspect of the present invention, even if the gas essential for power generation of the fuel cell is used, the pressure change due to power generation of the fuel cell can be suppressed. Therefore, even if the pressure difference between the fuel gas flow field and the oxygen-containing gas flow field is small, the pressure change due to a leak from the electrolyte membrane can be captured. As a result, the inspection of a leak from the electrolyte membrane can be performed using limited resources.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a fuel cell system;

FIG. 2 is a cross-sectional view showing a unit cell;

FIG. 3 is a flow chart showing the procedure of a leak inspection method;

FIG. 4 is a flow chart showing the procedure of steps related to voltage monitoring in the leak inspection method;

FIG. 5 is a cross-sectional view showing a unit cell of planar array type; and

FIG. 6 is a graph showing the amount of pressure change.

### DETAILED DESCRIPTION OF THE INVENTION

### First Embodiment

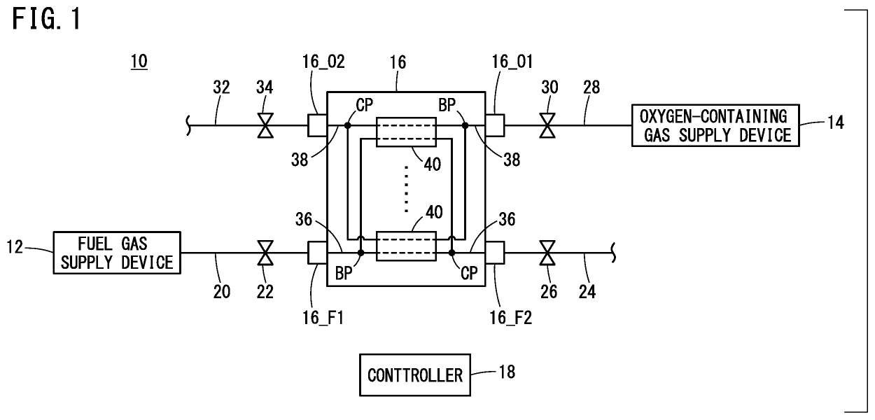

FIG. 1 is a schematic diagram showing a fuel cell system 10. The fuel cell system 10 is mounted in a mobile body capable of flying in space. The fuel cell system 10 is provided with a fuel gas supply device 12, an oxygen-containing gas supply device 14, a fuel cell 16, and a controller 18.

The fuel gas supply device 12 is a device capable of supplying high-pressure fuel gas. The fuel gas is a gas containing hydrogen. The fuel gas supply device 12 may include an electrochemical hydrogen pump and a fuel gas tank. The electrochemical hydrogen pump compresses hydrogen through redox reaction of hydrogen to produce high-pressure fuel gas. The fuel gas tank stores the high-pressure fuel gas generated by the electrochemical hydrogen pump.

The oxygen-containing gas supply device 14 is a device capable of supplying high-pressure oxygen-containing gas. The oxygen-containing gas is a gas containing oxygen. The oxygen-containing gas may be air. The oxygen-containing gas supply device 14 may include a water electrolysis device and an oxygen-containing gas tank. The water electrolysis device compresses oxygen by electrolysis of water to produce high-pressure oxygen-containing gas. The oxygen-containing gas tank stores the high-pressure oxygen-containing gas.

When the fuel gas supply device 12 includes an electrochemical hydrogen pump and the oxygen-containing gas supply device 14 includes a water electrolysis device, the electrochemical hydrogen pump may compress hydrogen produced by the water electrolysis device through electrolysis of water. In this case, the efficiency of hydrogen utilization can be improved.

The fuel cell 16 includes a fuel gas inlet 16_F1, a fuel gas outlet 16_F2, an oxygen-containing gas inlet 16_O1, and an oxygen-containing gas outlet 16_O2.

The fuel gas inlet 16_F1 is connected to the first end portion of a fuel gas supply conduit 20. The second end of the fuel gas supply conduit 20 is connected to the fuel gas supply device 12. When a first open/off valve 22 provided to the fuel gas supply conduit 20 is closed, high-pressure fuel gas is not supplied from the fuel gas supply device 12 to the fuel cell 16. On the other hand, when the first open/off valve 22 is open, the high-pressure fuel gas is supplied from the fuel gas supply device 12 to the fuel cell 16. In this case, the fuel gas flows into the fuel cell 16 from the fuel gas inlet 16_F1. The opening and closing of the first open/off valve 22 is controlled by the controller 18.

The fuel gas outlet 16_F2 is connected to the first end of a fuel gas discharge conduit 24. The second end portion of the fuel gas discharge conduit 24 may be located in an external space. The second end of the fuel gas discharge conduit 24 may be connected to a predetermined location of the fuel gas supply conduit 20. In this case, since the fuel gas can be circulated without being purged, the fuel gas utilization efficiency can be improved. When a second open/off valve 26 provided to the fuel gas discharge conduit 24 is closed, the flow of fuel gas inside the fuel cell 16 is suppressed. On the other hand, when the second open/off valve 26 is open, the flow of the fuel gas inside the fuel cell 16 is not suppressed, and the off-gas containing the fuel gas is discharged from the fuel gas outflow port 16_F2 and flows through the fuel gas discharge conduit 24. The opening and closing of the second open/off valve 26 is controlled by the controller 18.

The oxygen-containing gas inlet 16_O1 is connected to the first end of the oxygen-containing gas supply conduit 28. The second end of the oxygen-containing gas supply conduit 28 is connected to an oxygen-containing gas supply device 14. When a third open/off valve 30 provided to the oxygen-containing gas supply conduit 28 is closed, high-pressure oxygen-containing gas is not supplied from the oxygen-containing gas supply device 14 to the fuel cell 16. On the other hand, when the third open/off valve 30 is open, high-pressure oxygen-containing gas is supplied from the oxygen-containing gas supply device 14 to the fuel cell 16. In this case, the oxygen-containing gas flows into the fuel cell 16 from the oxygen-containing gas inlet 16_O1. The opening and closing of the third open/off valve 30 is controlled by the controller 18.

The oxygen-containing gas outlet 16_O2 is connected to the first end of the oxygen-containing gas discharge conduit 32. The second end of the oxygen-containing gas discharge conduit 32 may be located in an external space. The second end of the oxygen-containing gas discharge conduit 32 may be connected to a predetermined location of the oxygen-containing gas supply conduit 28. In this case, since the oxygen-containing gas can be circulated without being purged, the utilization efficiency of the oxygen-containing gas can be improved. When a fourth open/off valve 34 provided to the oxygen-containing gas discharge conduit 32 is closed, the flow of oxygen-containing gas inside the fuel cell 16 is suppressed. On the other hand, when the fourth open/off valve 34 is open, the flow of the oxygen-containing gas inside the fuel cell 16 is not suppressed, and the off-gas containing the oxygen-containing gas is discharged from the oxygen-containing gas outlet 16_O2 and flows through the oxygen-containing gas discharge conduit 32. The opening and closing of the fourth open/off valve 34 is controlled by the controller 18.

The fuel cell 16 further includes a fuel gas flow field 36, an oxygen-containing gas flow field 38, and one or more unit cells 40. FIG. 1 shows an example where the fuel cell 16 includes a plurality of unit cells 40.

The fuel gas flow field 36 is formed inside the fuel cell 16. The first end of the fuel gas flow field 36 is connected to the fuel gas inlet 16_F1. The second end of the fuel gas flow field 36 is connected to the fuel gas outlet 16_F2. The fuel gas flow field 36 passes through the unit cell 40. When there are a plurality of unit cells 40, the fuel gas flow field 36 branches inside the fuel cell 16 and merges after passing through each unit cell 40 without communication with each other.

The oxygen-containing gas flow field 38 is formed inside the fuel cell 16 without communicating with the fuel gas flow field 36. The first end of the oxygen-containing gas flow field 38 is connected to the oxygen-containing gas inlet 16_O1. The second end of the oxygen-containing gas flow field 38 is connected to the oxygen-containing gas outlet 16_O2. The oxygen-containing gas flow field 38 passes through the unit cell 40. When there are a plurality of unit cells 40, the oxygen-containing gas flow field 38 branches inside the fuel cell 16 and merges after passing through each unit cell 40 without communicating with each other.

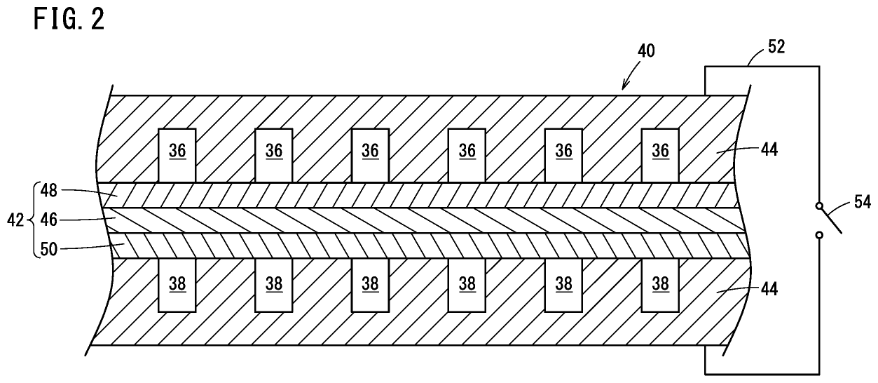

The unit cell 40 generates electricity through the electrochemical reaction between fuel gas and oxygen-containing gas. FIG. 2 is a cross-sectional view showing the unit cell 40. The unit cell 40 has a membrane electrode assembly 42 and a pair of separators 44. When the fuel cell 16 includes a plurality of unit cells 40, the plurality of unit cells 40 are stacked. In this case, the plurality of unit cells 40 are electrically connected in series. The membrane electrode assembly 42 has an electrolyte membrane 46, an anode 48, and a cathode 50.

The electrolyte membrane 46 is, for example, a solid polymer electrolyte membrane (cation exchange membrane) such as a thin film of perfluorosulfonic acid containing water. The electrolyte membrane 46 may be a fluorine-based electrolyte membrane or an HC (hydrocarbon)-based electrolyte membrane. The electrolyte membrane 46 is sandwiched between the anode 48 and the cathode 50.

The anode 48 faces one surface of the electrolyte membrane 46. The second surface of the anode 48 on the opposite side to the first surface of the anode 48 facing the electrolyte membrane 46 faces the separator 44. Part of the fuel gas flow field 36 is formed between the anode 48 and the separator 44. The fuel gas flow field 36 formed between the anode 48 and the separator 44 extends along the second surface of the anode 48. Part of the fuel gas passing on the second surface of the anode 48 is decomposed into hydrogen ions and electrons at the anode 48. The anode 48 may include an anode catalyst layer and an anode diffusion layer. The anode catalyst layer is a layer containing a catalyst for the oxidation reaction of hydrogen contained in the fuel gas. The anode diffusion layer is a layer for diffusing the fuel gas flowing through the fuel gas flow field 36 and supplying it to the anode catalyst layer.

The cathode 50 faces the other surface of the electrolyte membrane 46. The second surface of the cathode 50 on the opposite side to the first surface of the cathode 50 facing the electrolyte membrane 46 faces the separator 44 that is different from the separator 44 the second surface of the anode 48 faces. Part of the oxygen-containing gas flow field 38 is formed between the cathode 50 and the separator 44. The oxygen-containing gas flow field 38 formed between the cathode 50 and the separator 44 extends along the second surface of the cathode 50. Part of the oxygen-containing gas passing on the second surface of the cathode 50 reacts with the hydrogen ions having permeated through the electrolyte membrane 46 at the cathode 50 to produce water. The cathode 50 may include a cathode catalyst layer and a cathode diffusion layer. The cathode catalyst layer is a layer containing a catalyst for the reduction reaction of oxygen. The cathode diffusion layer is a layer for diffusing the oxygen-containing gas flowing through the oxygen-containing gas flow field 38 and supplying it to the cathode catalyst layer.

The anode 48 and the cathode 50 are connected by wiring 52. The wiring 52 electrically connects the anode 48 and the cathode 50 without passing through the electrolyte membrane 46. When a switch 54 provided to the wiring 52 is on, electrons separated at the anode 48 are led to the cathode 50. When the switch 54 provided to the wiring 52 is off, electrons separated at the anode 48 are not led to the cathode 50.

The controller 18 has a processor and a storage medium. The storage medium may include volatile memory and non-volatile memory. The volatile memory may include a RAM or the like. Examples of the non-volatile memory include a ROM, a flash memory, or the like.

The controller 18 controls the fuel gas supply device 12. In this case, the controller 18 can start the supply of fuel gas to the fuel cell 16 and stop the started supply of fuel gas. The controller 18 controls the oxygen-containing gas supply device 14. In this case, the controller 18 can start the supply of oxygen-containing gas to the fuel cell 16 and stop the started supply of oxygen-containing gas. The controller 18 controls the first open/close valve 22, the second open/close valve 26, the third open/close valve 30, and the fourth open/close valve 34. In this case, the controller 18 may open and close at least one of the first open/off valve 22, the second open/off valve 26, the third open/off valve 30, and the fourth open/off valve 34. The controller 18 may turn on the switch 54 to electrically connect the anode 48 and the cathode 50 with each other and turn off the switch 54 to electrically disconnect the anode 48 and the cathode 50 from each other.

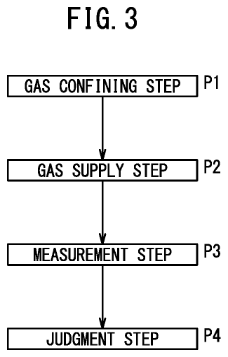

Next, the leakage inspection method for inspecting leak (cross-leak) through the electrolyte membrane 46 in the unit cell 40 will be described. FIG. 3 is a flow chart showing the procedure of the leak inspection method.

The leak inspection method includes a gas confining step P1, a gas supply step P2, a measurement step P3, and a judgment step P4.

The gas confining step P1 is a step of confining the fuel gas in the fuel gas flow field 36. In the gas confining step P1, the controller 18 opens the first open/close valve 22 and closes the second open/close valve 26. Thereafter, the controller 18 controls the fuel gas supply device 12 to start the supply of fuel gas to the fuel cell 16. When the pressure of the fuel gas in the fuel gas flow field 36 reaches a predetermined pressure, the controller 18 closes the first open/close valve 22. The pressure of the fuel gas in the fuel gas flow field 36 is measured using a pressure sensor.

The pressure sensor is provided to the fuel gas flow field 36. When the fuel cell 16 includes a plurality of unit cells 40, the number and arrangement of pressure sensors on the fuel gas flow field 36 can be selected as appropriate. For example, one pressure sensor may be provided to the fuel gas flow field 36 upstream of a branch portion BP (FIG. 1). Alternatively, one pressure sensor may be provided to the fuel gas flow field 36 downstream of a merging portion CP (FIG. 1). Alternatively, one pressure sensor may be provided to the fuel gas flow field 36 formed between the anode 48 and the separator 44 of each unit cell 40. The location of the pressure sensor is not limited to the fuel gas flow field 36. For example, the pressure sensor may be installed at the fuel gas supply line 20 downstream of the first open/close valve 22 or at the fuel gas discharge conduit 24 upstream of the second open/close valve 26.

The gas supply step P2 is a step of continuing to supply the oxygen-containing gas to the oxygen-containing gas flow field 38. In the gas supply step P2, the controller 18 opens the third open/off valve 30 and the fourth open/off valve 34. Thereafter, the controller 18 controls the oxygen-containing gas supply device 14 to start the supply of oxygen-containing gas to the fuel cell 16. In the present embodiment, the oxygen-containing gas is supplied at a pressure higher than the pressure of the fuel gas confined in the fuel gas flow field 36. For example, fuel gas is confined in the fuel gas flow field 36 at a pressure of 30 kPa, and oxygen-containing gas at a pressure of 40 kPa is continued to be supplied to the oxygen-containing gas flow field 38.

The measurement step P3 is a step of measuring the amount of pressure change per unit time of the gas confined in the gas confining step P1. In the measurement step P3, the controller 18 first turns off the switch 54 provided to the wiring 52. The controller 18 may turn off the switch 54 before the gas confining step P1 or the gas supply step P2. When the switch 54 is in an OFF state, the power generation of the unit cell 40 is suppressed. Therefore, the pressure drop of the fuel gas confined in the fuel gas flow field 36 due to the power generation in the unit cell 40 is suppressed. When the switch 54 is turned off, the controller 18 stores the pressure detected by the aforementioned pressure sensor in the storage medium. Based on the pressure stored in the storage medium, the controller 18 also acquires the amount of pressure change, for example, when a predetermined time has passed since the switch 54 was turned off.

When the electrolyte membrane 46 is broken and no pin holes or the like are present at the electrolyte membrane 46, the pressure of the fuel gas confined in the fuel gas flow field 36 is approximately constant. On the other hand, when pinholes or the like are formed at the electrolyte membrane 46, the pressure of the gas confined in the gas confining step P1 changes according to the pressure difference between the fuel gas flow field 36 and the oxygen-containing gas flow field 38. In the present embodiment, the pressure of the oxygen-containing gas continuously supplied to the oxygen-containing gas flow field 38 is larger than the pressure of the fuel gas confined in the fuel gas flow field 36. Therefore, the fuel gas confined in the fuel gas flow field 36 leaks into the oxygen-containing gas flow field 38 via the electrolyte membrane 46. Therefore, the pressure of the fuel gas confined in the fuel gas flow field 36 increases.

The judgment step P4 is a step of determining the presence or absence of leak from the electrolyte membrane 46 based on the amount of pressure change per unit time of the gas measured in the measurement step P3. In the judgment step P4, the controller 18 compares the amount of pressure change measured in the measurement step P3 with a predetermined threshold value. If the amount of pressure change does not exceed the threshold value, the controller 18 determines that there is no leak from the electrolyte membrane 46. In this case, the controller 18 may activate an alerting device, such as a display device, connected to the controller 18 to indicate that there is no leak from the electrolyte membrane 46. On the other hand, if the amount of pressure change exceeds the threshold value, the controller 18 determines that there is a leak from the electrolyte membrane 46. In this case, the controller 18 may activate an alerting device, such as a display device, connected to the controller 18 to warn that there is a leak from the electrolyte membrane 46.

As described above, in the leak inspection method of the present embodiment, the fuel gas is confined in the fuel gas flow field 36 at a predetermined pressure, and the oxygen-containing gas at a pressure higher than the pressure of the confined fuel gas is continuously supplied to the oxygen-containing gas flow field 38. Thus, in the leak inspection method of the present embodiment, the leakage inspection can be performed using only the gas essential for power generation of the fuel cell 16 while reducing the pressure difference between the fuel gas flow field 36 and the oxygen-containing gas flow field 38. Therefore, the breakage of the electrolyte membrane 46 due to an excessive pressure difference between the fuel gas flow field 36 and the oxygen-containing gas flow field 38 can be suppressed.

In addition, in the leak inspection method of this embodiment, the amount of pressure change per unit time of the confined fuel gas is measured when the switch 54 is in the OFF state that is provided to the wiring 52 connecting the anode 48 and the cathode 50 without passing through the electrolyte membrane 46. In a state where the anode 48 and the cathode 50 are disconnected, the power generation of the unit cell 40 is suppressed. Therefore, in the leak inspection method of the present embodiment, although the gas essential for power generation is used, pressure changes due to power generation can be suppressed. Therefore, even if the pressure difference between the fuel gas flow field 36 and the oxygen-containing gas flow field 38 is small, the pressure drop due to the leak from the electrolyte membrane 46 can be captured.

In the leak inspection method, the voltage applied to the fuel cell 16 is monitored after the fuel gas is confined in the fuel gas flow field 36 and the oxygen-containing gas is supplied to the oxygen-containing gas flow field 38. When the fuel cell 16 has one unit cell 40, the voltage applied across one unit cell 40 is monitored. On the other hand, when the fuel cell 16 has a plurality of unit cells 40, the voltage applied across the plurality of unit cells 40 electrically connected in series may be monitored, or the voltage applied to each unit cell 40 may be monitored.

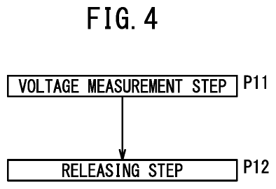

FIG. 4 is a flow chart showing the procedure of steps related to voltage monitoring in the leak inspection method. The leak inspection method further includes a voltage measurement step P11 and a releasing step P12.

The voltage measurement step P11 is a step of measuring the voltage applied to the fuel cell 16. In the voltage measurement step P11, after the fuel gas has been confined in the fuel gas flow field 36 and the oxygen-containing gas has started to be supplied to the oxygen-containing gas flow field 38, the controller 18 starts to measure the voltage value applied to the fuel cell 16.

The releasing step P12 is a step of releasing the confining of the fuel gas when the voltage value measured in the voltage measurement step P11 becomes less than a predetermined voltage threshold value. In the releasing step P12, the controller 18 compares the voltage value measured in the voltage measurement step P11 with the voltage threshold value stored in the storage medium.

In the case where there is a leak from the electrolyte membrane 46 or the like, the fuel gas and the oxygen-containing gas may directly react with each other to eventually cause ignition. When the direct reaction between the fuel gas and the oxygen-containing gas continues, the voltage value applied to the fuel cell 16 decreases. When the voltage value measured in the voltage measurement step P11 becomes less than the voltage threshold value, the controller 18 opens the second open/off valve 26 to release the confining of the fuel gas. This makes it possible to suppress the ignition of the unit cell 40 in advance.

The controller 18 may open the second open/close valve 26 to release the confining of the fuel gas after stopping the supply of the oxygen-containing gas to the oxygen-containing gas flow field 38 by controlling the oxygen-containing gas supply device 14. In this case, the electrolyte membrane 46 can be prevented from being damaged because of the pressure difference between the fuel gas flow field 36 and the oxygen-containing gas flow field 38.

### Second Embodiment

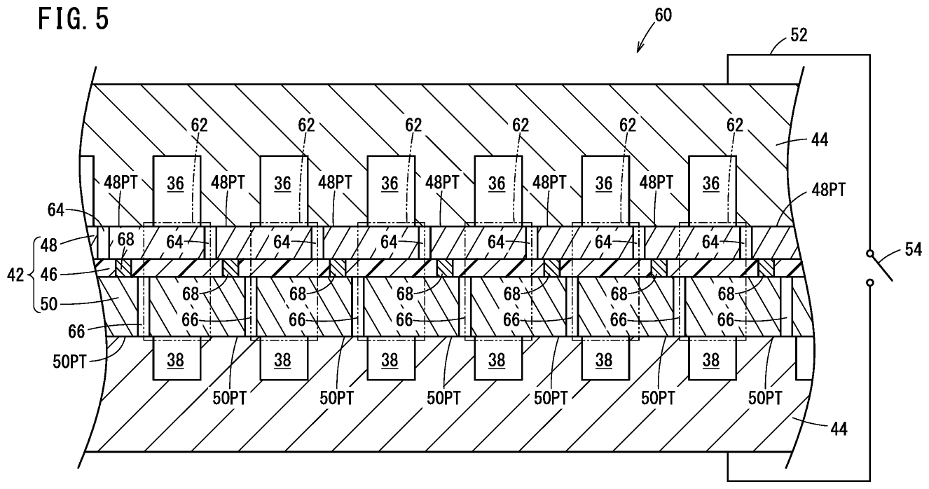

In this embodiment, the unit cell 40 of the first embodiment is replaced by a unit cell 60 of planar array type (FIG. 1). FIG. 5 is a cross-sectional view showing a unit cell 60 of planar array type. In FIG. 5, components equivalent to those described in the first embodiment are denoted by the same reference numerals. In this embodiment, explanations that overlap with those of the first embodiment are omitted.

In the unit cell 60 of planar array type, a plurality of cell blocks 62 are formed. In FIG. 5, part of a cell block 62 is surrounded by a dashed line for ease of understanding. Each cell block 62 includes, as components, one anode portion 48PT, one cathode portion 50PT, and an electrolyte membrane 46 disposed between these electrode portions.

The anode portion 48PT is part of the anode 48. The anode portion 48PT is formed by dividing grooves 64. That is, the anode 48 is divided into a plurality of anode portions 48PT by the dividing grooves 64. The dividing groove 64 extends along the fuel gas flow field 36 between the anode 48 and the separator 44 from the first edge of the anode 48 to the second edge on the opposite side to the first edge. The anode portion 48PT may have a rectangular shape in which the long side is the extension direction of the dividing groove 64 and the short side is between two dividing grooves 64.

The cathode portion 50PT is part of the cathode 50. The cathode portion 50PT is formed by the dividing grooves 66. That is, the cathode 50 is divided into a plurality of cathode portions 50PT by the dividing grooves 66. The dividing groove 66 extends from the first edge of the cathode 50 to the second edge on the opposite side to the first edge along the oxygen-containing gas flow field 38 provided between the cathode 50 and the separator 44. The cathode portion 50PT may have a rectangular shape in which the long side is the extension direction of the dividing groove 66 and the short side is between two dividing grooves 66.

A plurality of cell blocks 62 are connected in series by inter-connector portions 68. The inter-connector portion 68 electrically connects the anode portion 48PT and the cathode portion 50PT. The inter-connector portion 68 connects the anode portion 48PT of one of adjacent cell blocks 62 arranged along the surface direction of the electrolyte membrane 46 with the cathode portion 50PT of the other of the adjacent cell blocks 62. The inter-connector portion 68 is formed at the electrolyte membrane 46. The inter-connector portion 68 is formed, for example, by heating a local portion of the electrolyte membrane 46 to carbonize the local portion. The inter-connector portion 68 may be a conductive carbide derived from a proton conducting resin. Examples of the proton conductive resin include aromatic polymer compounds obtained by introducing sulfonic acid groups into hydrocarbon polymers such as aromatic polyarylene ether ketones and aromatic polyarylene ether sulfones.

In the unit cell 60 of planar array type, the anode portion 48PT and the cathode portion 50PT are electrically connected by the inter-connector portion 68. Therefore, even if the switch 54 provided to the wiring 52 is turned off, the unit cell 60 tends to generate a small amount of electricity. When the unit cell 60 generates power, it is not possible to distinguish whether the amount of pressure change measured in the measurement step P3 is caused by the power generation of the unit cell 60 or by the leak from the electrolyte membrane 46.

Therefore, when the leak from the electrolyte membrane 46 of the planar array type unit cell 60 is inspected, the reference amount of pressure change is used as the threshold value to be compared with the amount of pressure change in the judgment step P4. The reference amount of pressure change is set in advance as a reference indicating the amount by which the pressure of the confined gas drops per unit time because of power generation when there is no leak from the electrolyte membrane 46. The reference amount of pressure change is acquired by carrying out the gas confining step P1, the gas supply step P2, and the measurement step P3 described above for the fuel cell 16 in which it has been determined that there is no leak from the electrolyte membrane 46. The reference amount of pressure change may be acquired on the ground. The reference amount of pressure change may be a map (graph) showing the change in the pressure of the confined gas because of power generation when there is no leak from the electrolyte membrane 46.

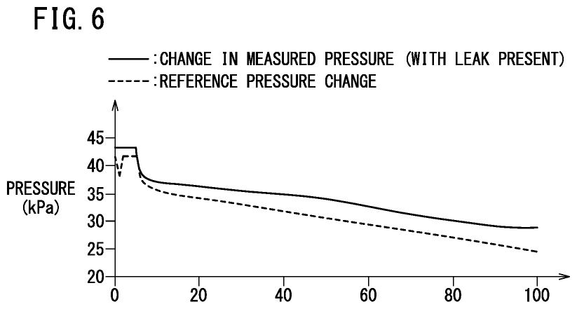

In the judgment step P4 of the present embodiment, the controller 18 compares the amount of pressure change measured in the measurement step P3 with the reference amount of pressure change stored in the storage medium. When there is a leak from the electrolyte membrane 46, the change in the gas pressure measured in the measurement step P3 becomes larger than the change (reference pressure change) in the gas pressure due to power generation (see FIG. 6). Therefore, the amount of pressure change measured in measurement step P3 increases more than the reference amount of pressure change.

When the difference between the amount of pressure change measured in the measurement step P3 and the reference amount of pressure change does not exceed a predetermined threshold value, the controller 18 determines that there is no leak from the electrolyte membrane 46. On the other hand, if the difference between the amount of pressure change and the reference amount of pressure change exceeds a threshold value, the controller 18 determines that there is a leak from the electrolyte membrane 46.

In this way, when the fuel cell 16 includes the unit cell 60 of the planar array type, the amount of pressure change measured in the measurement step P3 is compared with the reference amount of pressure change. This makes it possible to distinguish whether the amount of pressure change measured in the measurement step P3 is caused by power generation in the unit cell 40 or the leak from the electrolyte membrane 46.

The above-described embodiment may be modified in the following manner.

In the gas confining step P1, the oxygen-containing gas may be confined in the oxygen-containing gas flow field 38. In this case, in the gas supply step P2, the fuel gas is continuously supplied to the fuel gas flow field 36.

In addition, the pressure of the gas (oxygen-containing gas or fuel gas) continuously supplied in the gas supply step P2 may be smaller than the pressure of the gas (fuel gas or oxygen-containing gas) confined in the gas confining step P1.

When the fuel cell 16 includes planar array type unit cells 60, the pressure of the gas confined in the gas confining step P1 (fuel gas or oxygen-containing gas) and the pressure of the gas continuously supplied in the gas supply step P2 (oxygen-containing gas or fuel gas) may be the same.

The inventions understood based on the above are described below.

(1) The present invention is a leak inspection method of inspecting a leak from an electrolyte membrane (46) in a fuel cell (16) including the electrolyte membrane (46) and an anode (48) and a cathode (50) that sandwich the electrolyte membrane (46), the method including: a gas confining step (P1) of confining a fuel gas at a predetermined pressure in a fuel gas flow field (36) for supplying the fuel gas to the anode (48) or confining an oxygen-containing gas at a predetermined pressure in an oxygen-containing gas flow field (38) for supplying the oxygen-containing gas to the cathode (50); a gas supply step (P2) of continuing to supply the oxygen-containing gas at a pressure equal to or higher than the predetermined pressure or equal to or lower than the predetermined pressure to the oxygen-containing gas flow field (38) when the fuel gas is confined in the fuel gas flow field, and continuing to supply the fuel gas at a pressure equal to or higher than the predetermined pressure or equal to or lower than the predetermined pressure to the fuel gas flow field (36) when the oxygen-containing gas is confined in the oxygen-containing gas flow field (38); and a measurement step (P3) of measuring the amount of pressure change per unit time of the gas confined in the gas confining step (P1), when a switch (54) provided to a wiring (52) that connects the anode (48) and the cathode (50) without passing through the electrolyte membrane (46) is in an OFF state.

According to the present invention, it is possible to suppress the breakage of the electrolyte membrane due to the pressure difference between the fuel gas flow field and the oxygen-containing gas flow field by using only the gas that is essential for the power generation of the fuel cell. In addition, power generation of the fuel cell is suppressed when the anode and the cathode are not connected. Therefore, according to the present invention, even if the gas essential for the power generation of the fuel cell is used, the pressure change caused by the power generation of the fuel cell can be suppressed. Therefore, even if the pressure difference between the fuel gas flow field and the oxygen-containing gas flow field is small, the pressure change due to a leak from the electrolyte membrane can be captured. As a result, the inspection of a leak from the electrolyte membrane can be performed using limited resources.

(2) The present invention is a leakage inspection method, wherein when an anode portion (48PT) that is part of the anode (48), and a cathode portion (50PT) that is part of the cathode (50) are connected by an inter-connector portion (68) formed at the electrolyte membrane (46), the amount of pressure change measured in the measurement step (P3) is compared with a reference amount of pressure change set in advance, and the reference amount of pressure change indicates the amount by which the pressure of the gas confined in the gas confining step (P1) drops per unit time because of power generation, when there is no leak from the electrolyte membrane (46). This makes it possible to distinguish whether the amount of pressure change measured in the measurement step is caused by power generation or a leak from the electrolyte membrane.
(3) The present invention is a leak inspection method that further includes a releasing step (P12) of releasing the confining of the gas confined in the gas confining step (P1), when the voltage value applied to the fuel cell (16) becomes less than a predetermined voltage threshold value. This prevents the fuel gas and the oxygen-containing gas from directly reacting and igniting when there is a leak from the electrolyte membrane.
(4) The present invention is a leak inspection method wherein the releasing step (P12) releases the confining of the gas confined in the gas confining step (P1) after stopping the supply of the gas supplied in the gas supply step (P2). This prevents the electrolyte membrane from being damaged because of an excessive pressure difference between the fuel gas flow field and the oxygen-containing gas flow field.

The present invention is not limited to the above disclosure, and various modifications are possible without departing from the essence and gist of the present invention.

1. A leak inspection method of inspecting a leak from an electrolyte membrane in a fuel cell including the electrolyte membrane and an anode and a cathode that sandwich the electrolyte membrane, the method comprising:
a gas confining step of confining a fuel gas at a predetermined pressure in a fuel gas flow field for supplying the fuel gas to the anode or confining an oxygen-containing gas at a predetermined pressure in an oxygen-containing gas flow field for supplying the oxygen-containing gas to the cathode;
a gas supply step of continuing to supply the oxygen-containing gas at a pressure equal to or higher than the predetermined pressure or equal to or lower than the predetermined pressure to the oxygen-containing gas flow field when the fuel gas is confined in the fuel gas flow field, and continuing to supply the fuel gas at a pressure equal to or higher than the predetermined pressure or equal to or lower than the predetermined pressure to the fuel gas flow field when the oxygen-containing gas is confined in the oxygen-containing gas flow field; and
a measurement step of measuring an amount of pressure change per unit time of the gas confined in the gas confining step, when a switch provided to a wiring connecting the anode and the cathode without passing through the electrolyte membrane is in an OFF state.

2. The leak inspection method according to claim 1,
wherein
when an anode portion that is part of the anode, and a cathode portion that is part of the cathode are connected by an inter-connector portion formed at the electrolyte membrane, the amount of pressure change measured in the measurement step is compared with a reference amount of pressure change set in advance, and
the reference amount of pressure change indicates the amount by which the pressure of the gas confined in the gas confining step drops per unit time because of power generation, when there is no leak from the electrolyte membrane.

3. The leak inspection method according to claim 1, further comprising
a releasing step of releasing the confining of the gas confined in the gas confining step, when a voltage value applied to the fuel cell becomes less than a predetermined voltage threshold value.

4. The leak inspection method according to claim 3, wherein
the releasing step releases the confining of the gas confined in the gas confining step, after stopping the supply of the gas supplied in the gas supply step.
